(19) United States
(12) Patent Application Publication
(10) Pub. No.: US 2026/0250128 A1
(43) Pub. Date: Aug. 27, 2026

(54) CATALYTIC CONVERSION METHOD OF CARBONACEOUS FUEL INTO SYNTHESIS GAS AND APPARATUS FOR CATALYTIC CONVERSION OF CARBONACEOUS FUEL INTO SYNTHESIS GAS

(71) Applicants: Albin Czernichowski, Warszawa (PL); Janusz Przeorek, Warszawa (PL); Marek Tyksinski, Warszawa (PL)

(72) Inventors: Albin Czernichowski, Warszawa (PL); Janusz Przeorek, Warszawa (PL); Marek Tyksinski, Warszawa (PL)

(21) Appl. No.: 18/992,188

(22) PCT Filed: Jul. 8, 2023
(86) PCT No.: PCT/PL2023/000035

§ 371 Date: Jan. 8, 2025

(30) Foreign Application Priority Data
Jul. 8, 2022 (PL) P.441676

(51) Int. Cl. C01B 3/326; B01J 8/04; B01J 21/04; B01J 23/755; B01J 35/00; C01B 3/36; C01B 3/382; C01B 3/386; C01B 3/40; C01B 3/48; C10J 3/20; C10J 3/72; C10K 3/04

(52) U.S. Cl. CPC C01B 3/326; B01J 8/0453; B01J 21/04; B01J 23/755; B01J 35/19; C01B 3/36; C01B 3/382; C01B 3/386; C01B 3/40; C01B 3/48; C10J 3/20; C10J 3/723; C10K 3/04; B01J 2208/00061; B01J 2208/00646; B01J 2208/00716; C01B 2203/0261; C01B 2203/0283; C01B 2203/0861; C01B 2203/1058; C01B 2203/1082; C01B 2203/1241; C01B 2203/1604; C10J 2200/06; C10J 2200/12; C10J 2300/092; C10J 2300/0946; C10J 2300/0956; C10J 2300/1618

(57) ABSTRACT

A method for catalytic oxidizing conversion of combustible carbonaceous matter into synthesis gas using a partial oxidation (POX) method is characterized by oxidation of said carbonaceous matter, which is in gaseous, vapor, or ash-free form, with an oxidizing agent in the presence of two consecutive POX catalysts supported on layered carriers. The first layer catalyst consists of a mixture of nickel and cerium oxides with a weight ratio of Ki/Ce ranging from 0.5:1.0 to 1.0:1.0, exhibiting oxidizing properties towards said matter at temperatures ranging from 1200 to 800° C. The second layer catalyst comprises metallic nickel or a mixture of nickel and cerium oxides with a weight ratio of Ni/Ce ranging from 2.0:I:0 to 10.0:1.0, demonstrating reduction-recombinatory properties at temperatures ranging from 800 to 300° C.

The subject of the invention is a method of catalytic-oxidative conversion of combustible carbonaceous substances in the gaseous, vapor, liquid, and even dust phase into synthesis gas, i.e., a mixture of Hydrogen (H₂) and Carbon Monoxide (CO), also known as synthesis gas or “syngas.” The invention is also a plasma-catalytic reactor for carrying out such conversion, leading to the production of pure syngas.

Vast amounts of synthesis gas are currently produced primarily through steam reforming of methane or high-methane Natural Gas (NG):

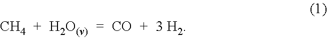

This is a highly endothermic reaction that takes place in the presence of specific nickel catalysts at temperatures ranging from 700 to 1100° C. The heat required for the process is supplied externally—that is, through the walls of metallic tubes filled with catalyst and heated from the outside by fully combusting an additional portion of methane (or NG) with the release of water vapor and carbon dioxide (CO₂):

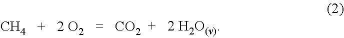

The syngas thus obtained is in 95% of cases catalytically converted (in a separate reactor) into additional Hydrogen through the weakly exothermic reaction with water vapor (Water Shift, WS):

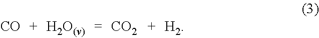

Reactions (1) and (3) can be combined, resulting in:

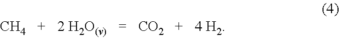

Considering this reaction (4) and additional combustion (2), where the emissions are released directly into the atmosphere, for every ton of produced hydrogen, approximately 9 to 11 tons of greenhouse gas CO₂ are produced using the best technology (and minimal losses). Hydrogen produced in this way is considered “grey” from an ecological point of view since it comes from fossil methane or NG.

A less common process for syngas production is partial oxidation (Partial Oxidation, POX of methane or NG):

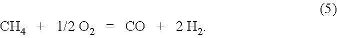

The reaction is weakly exothermic, and therefore, a slightly higher amount of oxidizer (O₂) is added (ε≤0.1) to achieve higher temperatures through complete, but internal, combustion of additional methane. The POX process is carried out, without a wall, in a completely different reactor and with a specific catalyst:

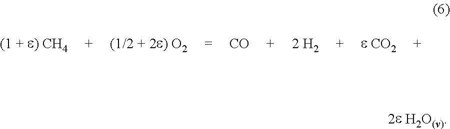

The process (6) must be carried out with special attention due to the explosive properties of the mixture of methane or NG and oxygen (e.g., from the air). Therefore, special burners/injectors are proposed in the technical literature. A solution to this “explosive” problem was the introduction of an electric arc at the entrance of the gases into the POX reactor, as described in patent FR 2593493, or the use of a GlidArc plasma generator, as described in patent FR 2768424. The latter document described a reactor with gas input surrounded by high-voltage discharge. The interior of the reactor contained pure metallic nickel rods as the catalyst for the POX reaction. A further improvement was proposed in patent FR 2873306, which introduced a GlidArc electric discharge type Vortex installed in the methane/NG and air mixer.

While steam reforming (SR) is a well-established technology for converting pure methane or high-methane Natural Gas (NG) into synthesis gas, the catalytic conversion of heavier hydrocarbons with water vapor carries the risk of catalyst deactivation due to the deposition of carbon, soot, or coke on its surface. However, this is not a problem in the case of the POX method. For example, patent FR 2933391 proposes a plasma-catalytic process for generating syngas from glycerol, and other reports describe various plasma-catalytic conversions, including propane, heavy hydrocarbon gases accompanying oil production, ethanol, gasoline, aviation kerosene, diesel oil, biodiesel, rapeseed or soybean oil, and even sugar syrup. It should be noted, however, that the accidental appearance of carbon or graphite in the plasma space generated using high voltage and supporting the POX of heavy carbonaceous matter poses a risk of short-circuiting for the electric power supply of the plasma generator itself, which is the unique guarantee of safety for the entire oxidation conversion.

The purpose of this invention is to solve this problem, opening the way for safe oxidative conversion of all combustible carbonaceous (fuel): gases vapor, liquids, and “organic” dust. This expands the base of renewable carbonaceous matter for the generation of “green” syngas, for example, for renewable energy, synthesis of paraffinic liquid fuels and waxes, or “green” hydrogen for electro-mobility. This base can finally include all biomass and various combustible carbonaceous waste/garbage generated by our civilization.

The method of catalytic-oxygenating conversion of combustible carbonaceous matter by the partial oxidation (POX) method to synthesis gas involves oxygenating this matter in gaseous, vapor, or ash-free liquid form. If the fuel is in solid form, it is subjected to prior pyrolysis, charring or pyro-gasification. Ash-free liquids and gases do not require such preliminary thermal treatment. Oxygenation is carried out using an oxygenating agent in the presence of two POX catalysts supported on carriers and arranged in layers.

The oxidizing catalyst in the first layer, which is the layer in contact with the fuel (gas, vapor, or dust) subjected to the POX operation, is a mixture of nickel and cerium oxides, with a weight ratio of Ni/Ce ranging from 0.5:1.0 to 1.0:1.0 and oxidative properties at temperatures ranging from 1200 to 800° C.

The reducing catalyst in the second, i.e., the next layer, is metallic nickel or a mixture of nickel and cerium oxides, with a weight ratio of Ni/Ce ranging from 2.0:1:0 to 10.0:1.0, and reducing-recombining properties at temperatures ranging from 800 to 300° C.

The temperatures inside these catalysts gradually change along the flow direction of the reactants from approximately 1200° C. at the contact with the first layer to around 300° C. at the outlet of the produced syngas from the second layer. The temperature of the first, initially cold catalyst layer at the cold-start of the reactor is raised to at least 750° C. using a gliding electric discharge GlidArc during the cold-start operation.

Advantageously, the carbonaceous fuel includes biomass, combustible industrial and agricultural waste, and solid or semi-liquid waste. This material should be initially gasified or subjected to charring or pyrolysis in a separate device and then further converted into volatile products of these operations in the proposed POX process. It is also possible to convert methane, natural gas NG, and heavier hydrocarbon gases or ash-free organic liquids into pure syngas. The term “carbonaceous fuel” in solid form and directly converted in the process described here also includes gases and liquids containing very fine solid particles, e.g., coal or wood dust.

Advantageously, atmospheric air or air enriched with oxygen (O₂) is used as the oxygenating agent for the carbonaceous fuel, but not exceeding 40% by volume to avoid fire. Such a concentration is also justified for economic reasons.

The catalysts are advantageously supported on porous walls of a multi-channel high-alumina ceramic monolith or a nickel monolith, or on porous high-alumina mineral granules.

Advantageously, after the second layer of the POX catalyst, an additional third layer of a WS catalyst is used, where total or partial conversion of CO into H₂ is carried out based on the water shift reaction (3). Any commercial WS catalyst known to specialists can be used, such as the copper catalyst Topsoe SK-201-2 with the addition of iron and chromium.

The flow of the oxygenating agent is advantageously established and regulated in relation to the temperature of the first catalyst layer such that when the temperature of the catalyst bed is below 750° C., the supply of the oxygenating agent is stopped for safety reasons. Below this temperature, the catalyst may not “ignite” the exothermic reaction of fully oxidizing a part of the carbonaceous fuel into CO₂ and H₂ described in reaction (6) by the coefficient ε—which may lead to thermal and chemical deactivation of the entire POX process.

Advantageously, the gliding electric discharge of the GlidArc type is reactivated when necessary to restore proper temperature distribution in the subsequent segments of the catalysts, especially at the first contact between the relatively cold mixture of incoming reactants (left side of equation 6) and the first oxidizing catalyst layer.

The pressure inside the reactor is advantageously maintained within the range of 0.8 to 1.2 absolute bar. This facilitates the construction and operation of the reactor according to the invention, called “SynGen.”

The essence of the invention is also a reactor designed for the catalytic-oxygenating conversion of carbonaceous fuel by the partial oxidation (POX) method to synthesis gas. The reactor according to the invention consists of an external tank and an internal tank placed inside it, with a perforated bottom/diaphragm. The internal tank contains two layered catalysts: an oxidizing catalyst and a reducing-recombinational catalyst supported on carriers. The first catalyst layer in relation to the flow of the reacting gas mixture is a mixture of nickel and cerium oxides, with a weight ratio of Ni/Ce ranging from 0.5:1.0 to 1.0:1.0 and oxidative properties at temperatures ranging from 1200 to 800° C. The second catalyst layer consists of nickel or a mixture of nickel and cerium oxides, with a weight ratio of Ni/Ce ranging from 2.0:1:0 to 10.0:1.0, and reducing-recombinational properties at temperatures ranging from 800 to 300° C. In this first catalyst layer, at least two independent temperature sensors are placed.

Both the external and internal tanks are covered with the same tight cover, which includes the inlet for volatile (gaseous, vapor, or dust) carbonaceous material and the oxygenating agent, as well as the electrodes for igniting and controlling plasma during the cold start of the reactor. The outlet from the reactor is a pipe attached to the wall of the larger tank.

Advantageously, below the last layer of the POX catalyst, an additional layer of WS catalyst is placed.

The catalyst carriers are advantageously multi-channel high-alumina ceramic monoliths with porous walls or nickel monoliths or porous high-alumina mineral granules.

The external surface of the external tank is advantageously covered with a layer of thermal insulation, such as mineral wool.

The cover of the tanks is advantageously protected by a thermal shield on the side facing the hottest oxidizing catalyst layer.

The reactor according to the invention is advantageously made entirely of metal, preferably of pure nickel.

In the method according to the invention, the first stage of converting complex carbonaceous fuel in solid or ashy liquid form into pure synthesis gas must involve the separation of ash, metals, glass, etc., from it. This stage is carried out in pyro-gasifiers, charring retorts, or pyrolysers, well-known devices for the initial gasification and partial or complete pyrolysis of various combustible carbonaceous materials. As a result of such processes, hot and ash-free vapor or gas substances are produced, such as carbon monoxide (CO), hydrogen (H₂), and a mixture of light and heavy hydrocarbons, as well as more complex volatile organic compounds mainly containing C, H, and O. After such initial thermal processing, the volatile, hot, and highly complex material, diluted with water vapor and nitrogen (N₂) from the added oxidizing agent, contains significant amounts of tars in the form of mists and vapors. Carbon (C) can also appear there in the form of soot, as well as some mineral dust. During pyrolysis of even a high-ash solid charge without the addition of an oxidizing agent/air, a large portion of the carbon remains as coke contaminated with mineral ash after the process. Other ash-free gaseous or liquid feedstocks do not require prior pyro-gasification or pyrolysis/charring.

The volatile and hot products after pyro-gasification, pyrolysis, or charring of complex carbonaceous materials are usually available at slightly higher pressure than atmospheric pressure. They are immediately introduced into the POX conversion reactor according to the present invention. Here, they are selectively oxygenated with atmospheric air, optionally enriched with oxygen. The exothermic process can be schematically described (without considering stoichiometry and the presence of nitrogen, sulfur, or chlorine compounds):

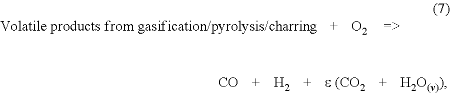

where ε denotes a small fraction of complete combustion of some of these incoming substances to heat them to the temperatures required for this selective catalysis and to compensate for heat losses in the reactor according to the invention.

In the case of ash-free gaseous and liquid carbonaceous fuels, there is no need for the stage of their initial thermal treatment. The process of their direct conversion to pure synthesis gas can then be schematically represented as:

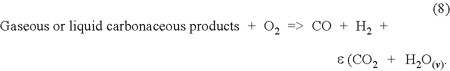

The exothermic reactions (7) or (8) and subsequent endothermic and recombination processes (utilizing the excess of hot molecules of CO₂ and H₂O) take place in progressively colder layers/portions of the catalytic matter in the reactor according to the invention, until finally, at a temperature of about 300° C., stable products of these processes are obtained in the form of moist and pure synthesis gas. Of course, reactions (7) or (8) occur in the presence of previously generated hydrogen (H₂) and carbon monoxide (CO) as well as other molecules such as N², H₂O₍ᵥ₎, and CO₂. However, the total amount of synthesis gas [H₂+CO] leaving the reactor is greater than that generated in any pyro-gasifiers or pyrolysers/retorts. This fact would suggest some selectivity of strongly exothermic oxidation only of heavier and undesirable components, e.g., pyro-gas, bypassing the already contained “primary” hydrogen and carbon monoxide in the gas. In reality, H₂ and CO also undergo partial oxidation on the first catalyst, but endothermic recombination processes occurring in the lower layers of the second catalyst, richer in nickel, revive these most valuable molecules abundantly. Such final synthesis gas is completely free of tars, organic, and carbonaceous dust, as well as undesirable other hydrocarbons and other organic substances.

Waste (and even junk) carbonaceous substances, which are subjected to pyro-gasification, charring, or pyrolysis, as well as other ash-free and combustible feedstocks that do not require such prior thermal treatment, are often contaminated with halogens [Fluorine (F), Chlorine (Cl), Bromine (Br)—denoted as (X)], nitrogen compounds, phosphorus, sulfur, silicon, and others. A large portion of these elements enters the reactor according to the invention in the form of various volatile hetero-organic compounds and undergoes partial oxidation, thermal dissociation, hydrolysis with high-temperature steam, and, above all, conversion to hydrogen (H₂) and carbon monoxide (CO)—thus providing an additional portion of synthesis gas. This is favored by the active and hot environment of the incoming products from the pyro-gasifier or pyrolyzer, i.e., H₂, CO, H₂O (v), and CO₂, the added portion ε of the oxidizing agent (atmospheric air or oxygen-enriched) that raises the temperatures in this reactor through partial combustion, and the specific properties of the catalytic filling of each of its layers. The special properties of this layered filling are the specific Ni/Ce composition and temperatures of the two consecutive segments. The hottest layers of the first catalyst promote the partial oxidation of the incoming carbonaceous matter, while the cooler layers of the second catalyst facilitate the processes of reduction and recombination of the components of this matter into stable and volatile end products, H₂+CO. In such conditions, various carbonaceous substances entering the reactor undergo initial oxidative decomposition, followed by a gradual recombination into very simple molecules such as H₂, CO, nitrogen (N₂), or ammonia (NH₃), hydrogen sulfide (H₂S), hydrogen halides (HX), silicon monoxide (SiO), and other simple and volatile compounds that persist in the strongly reducing and still sufficiently hot atmosphere of H₂ and CO (and inert N₂) in the final layers of the second catalyst.

The end product can also be a hydrogen concentrate obtained in reaction (3) when the next, third layer of the catalyst contains a commercial catalyst dedicated to the WS process.

According to the invention, for the cold start of the reactor, a gliding electrical discharge of the GlidArc type is used. Thanks to this, the first catalyst layer (the one supporting the process of oxidizing undesirable feedstock molecules), especially the part of the catalyst directly in contact with such an electro-flame with a large excess of oxidizing agent O₂, is quickly and safely brought to a temperature of at least 750° C. After such reactor start-up, the plasma assistance can be turned off, and this part of the catalyst can be brought to the temperature of its optimal activity thanks to the presence of the already preheated catalyst in the first layer, the strongly oxidizing one. In the stable operation phase of the reactor, plasma may no longer be used. However, the plasma head along with its electrical supply can be reactivated at any time if necessary to restore the proper temperature distribution in the successive catalyst layers.

The specific filling of the inner tank can be loosely packed mineral and porous high-alumina granules or layers of porous ceramic (or nickel) monoliths with channels through which the gas/vapor mixture subjected to partial oxidation to synthesis gas is passed. This mixture may contain fine mineral dust as a residue from the pyro-gasification or pyrolysis/charring process, dust that could block the catalysts in the form of granules/pellets but can pass through the channels. Active catalysts of the POX process are in this case deposited on the extensive surface of porous ceramic or nickel channels, or metallic nickel with catalytic properties forming the channels.

The drawings show:

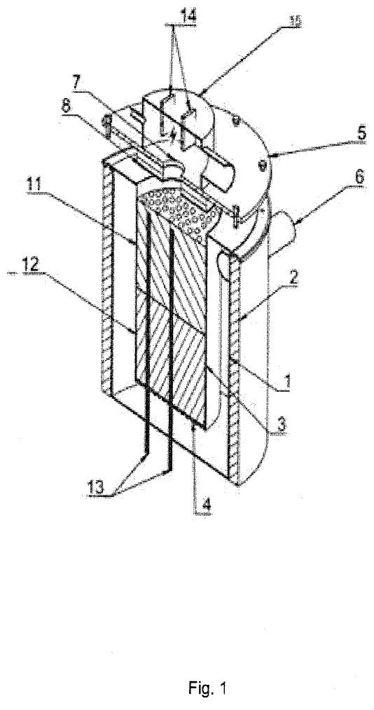

FIG. 1—an exemplary vertical reactor according to the invention in a schematic view; (similar reactors can be set in any position with respect to Gravity),

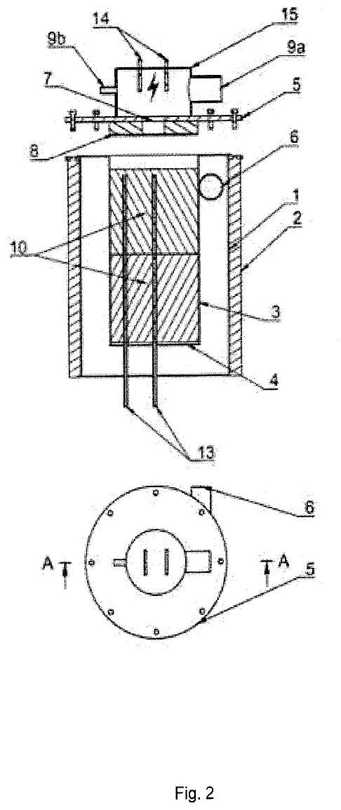

FIG. 2—the reactor according to the invention in a longitudinal section,

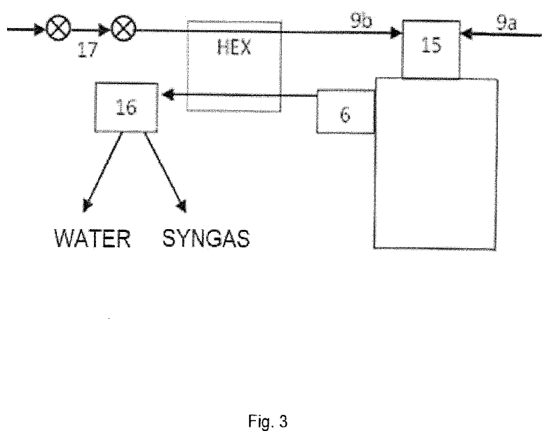

FIG. 3—a block diagram of the flow of matter in the process according to the invention.

The reactor according to the invention presented in the exemplary embodiment in FIG. 1 and FIG. 2 consists of an outer tank 1 thermally insulated from the surroundings by a sheath 2. Inside this tank 1, there is an inner tank 3 with a perforated bottom/diaphragm 4. Inside the inner tank 3, there are layers of catalysts 10 arranged one above the other and deposited on mineral and porous granules/pellets or in ceramic or metallic monoliths with channels.

The first, higher positioned layer 11 of the catalyst has oxidizing properties at temperatures ranging from 800 to 1200° C. The second, lower positioned layer 12 of another catalyst has recombining properties at temperatures ranging from 300 to 800° C. Individual sections of the monoliths or loosely piled layers of catalyst pellets have specific chemical compositions and carrier morphologies: they are high-alumina and porous. In the first, hottest layer/segment of the catalyst, two independent temperature sensors 13 are placed. The outer tank 1 and inner tank 3 are covered with a tight cover 5, in which there is a collective inlet 7 for carbonaceous matter to be purified/converted 9a, and oxidizing agent 9b, as well as electrodes 14 used to ignite the plasma for cold reactor start-up—and then to sustain its operation when needed. The outlet from the reactor is a pipe 6 attached to the wall of the larger outer tank 1.

The final products of the process pass through the perforated bottom/diaphragm 4 into the space between the walls of both tanks 1 and 3. The tight cover 5 simultaneously covers both tanks 1 and 3 in such a way that the only outlet for the conversion products from the reactor is the tangential pipe 6 attached to the wall of the larger tank 1. This attachment forces a swirling motion of the conversion products in the space between the tanks and enhances and unifies the heat exchange between them. The central opening 7 in the cover 5 is also used for the axial attachment of the head 15 consisting of a safe mixer of the oxidizing agent 9b and the volatile, hot (up to 350° C. and possibly soot or dust-laden) substrate 9a for conversion in the reactor. The cover 5 is protected from below by a shield 8—to prevent its excessive heating from the thermal radiation emitted by the upper layer or segment of the very hot catalyst 11 placed in the inner tank 3. In the bottom/diaphragm of the outer tank 1, there are tightly mounted long probes 13 (thermocouples, several in each tight tube and at different heights) for determining the temperature profile in several key layers/sections of the catalysts. Particularly important are the temperatures in the topmost layer/section of the catalyst closest to the cover 5; it is precisely at least two independently (duplicated) signals from this location that regulate/control the optimal and safe conversion of the initial/dirty carbonaceous matter into clean synthesis gas.

FIG. 3 shows a block diagram of the flow of matter in the process according to the invention. In the head 15 of the reactor, the “dirty” hot gas (GAZ 9a) from the pyro-gasifier (or pyrolyser/retort) or other volatile or vapor carbonaceous substance is mixed with the preheated oxidizing agent OX 9b (atmospheric or oxygen-enriched air). The preheating of the oxidizing agent OX occurs in the heat exchanger HEX, which cools the hot and clean synthesis gas leaving the reactor through the outlet 6. The partially cooled synthesis gas is then directed to the water vapor condenser 16 and then to the combined heat and power generation module or some other module, such as Fischer-Tropsch synthesis of paraffinic hydrocarbons, extraction of pure hydrogen, etc.

The entire gas from the pyro-gasifier or pyrolyser/charring unit is sent to the reactor only after preheating the reactor through complete oxidation of a small stream of any fuel (including even dirty syngas or pyrogas). Then, in this head 15, the entire stream of primary (dirty) syngas or pyrogas or GZ or other hydrocarbon gas or carbonaceous vapors/liquids is mixed with the oxidizer (OX) heated to a maximum of 350° C. with the heat of the clean syngas leaving the reactor (300 to 500° C.). Two series and independent valves 17 cutting off the oxidizer OX flow are controlled by two independent temperature probes 13 immersed in the hottest part of the first catalytic bed located in the inner tank 3. They shut off the flow of oxidizer OX at temperatures below 750° C., which safely stops the process, which can be restarted again.

To the head/mixer 15, the heated oxidizer (atmospheric air or oxygen-enriched air) is added with the intensity precisely regulated by a mass flow meter controlled with the help of the mentioned thermocouples 13 immersed in the hottest (up to 1200° C.) layer of the first catalyst. There, the overall exothermic reaction (7) or (8) takes place. Subsequent processes occur in the successive layers of the first and then second catalyst packed into the inner tank 3 or deposited on successive layers of multi-channel ceramic or metallic monoliths. These are recombinations occurring in deeper and colder layers of the catalytic material until stable products of these processes pass through the perforated bottom/diaphragm 4 of the inner tank 3 at temperatures ranging from 300 to 800° C., exit through the tangential outlet 6, and are directed through the heat exchanger HEX to the water vapor condenser 16, cooled, for example, with air. Here, water is collected without tars and other organic compounds. Thermal power of condensation of water vapor can also be recovered here. The final clean syngas is slightly moist (contains saturated water vapor at the condenser/chiller temperature).

The clean syngas obtained according to the invention can be used for various chemical syntheses, e.g., for the synthesis of paraffin waxes through the Fischer-Tropsch process. Such a synthesis can, therefore, take place not only in large petrochemical complexes based on fossil carbonaceous materials but also on a local scale in small and distributed installations, such as those described in the patent FR 2824755, located near available biomass, waste, carbonaceous liquid waste, volatile hydrocarbons accompanying oil production, landfill gas, biogas, methane from coal seams, refinery gases, etc.

Such clean syngas can also serve as a small, local, and “green” source of electricity and heat on a scale of up to 2 MW (per container) through reciprocating or turbine cogeneration systems or approximately twice as efficient fuel cells with molten carbonate (e.g., MCFC, Molten Carbonate Fuel Cell). For the purposes of “New Mobility” related to low-temperature hydrogen fuel cells (Proton-Exchange Membrane Fuel Cells PEMFC), hydrogen (H₂) can also be extracted from the syngas enriched with this modern fuel as a result of the reaction (3) WS occurring in the added layers of granulate/pellets or monolith with a commercial catalyst, layers placed just above the bottom/diaphragm 4 of the reactor according to the invention. All the water vapor from the process (or added water vapor) would then react with carbon monoxide (CO), and the condenser 16 would not be necessary.

The subject of the invention has been further presented in the examples.

### Example 1. Conversion of Gas from the Pyro-Gasification of a Mixture of Deciduous Wood, Coniferous Wood, Deciduous Bark, and Coniferous Bark

The carbonaceous material consisting of equal weight portions of the above biomass, with a relative humidity of 19% and a calorific value of 17 MJ/kg, underwent a pyro-gasification process. The hourly intensity (0.14 tons/h) of feeding this charge corresponded to an initial thermal/enthalpic power of 0.66 MW (the “higher value” HV considering the condensation of water vapor). Atmospheric air was supplied for pyro-gasification, resulting in a very humid dirty process gas containing 49 g of tars per 1 m³(n). After condensing water vapor and tars, about 54 L/h of water was obtained, containing nearly 13 kg/h of difficult-to-separate tars.

The process gas leaving the pyro-gasifier, however, was not cooled but thermally isolated from the environment to maintain its temperature, at least 120° C., to avoid the condensation of water vapor and tars. Such a feed (gas/vapor/mist) was immediately sent through a thermally insulated pipe to a nearby SynGen reactor according to the invention, schematically presented in FIG. 1, to carry out the selective conversion of tars and other carbonaceous gases and vapors into an additional portion of clean synthesis gas. The composition of this humid and tarry “primary” syngas was as follows (determined using an Agilent 490 gas chromatograph in volume %): CO 28; H₂ 5.7; (N₂+Ar) 34; H₂O₍ᵥ₎ 26; CO₂ 1.7; CH₄ 1.6; (C₂ to C₄) 1.5; C₁₀H₈ (naphthalene, assumed as an averaged tar, separately measured gravimetrically) 0.9. The calculated flow rate of this gas-vapor substrate to the reactor was 250 m³(n)/h, corresponding to a power of 0.57 MW (HV).

The first portion of gas from the pyro-gasifier was sent to the reactor according to the invention only after preheating the reactor by sustaining, through electric discharge between the electrodes 14, complete combustion of temporarily added propane mixed in the head 15 with air. Then, in the same head, the entire stream of primary (dirty) syngas was mixed with air (OX) heated in the heat exchanger (HEX) to 350° C. with the heat of the clean syngas leaving the reactor (400° C.). Two independent valves 17 (in series) cutting off the oxidizer OX flow were controlled by two independent temperature probes 13 immersed in the hottest part of the upper catalytic bed located in the inner tank 3. They shut off the flow of oxidizer OX at temperatures below 750° C.

Heated air was added to the head/mixer 15 at a rate of 140-150 kg/h, precisely regulated by a mass flow meter controlled with the help of the mentioned thermocouples 13 immersed in the hottest (1040° C.) upper layer of the first catalyst, which was a mixture of nickel and cerium oxides, in a weight ratio of Ni/Ce=0.7 on a carrier in the form of high-alumina and porous ceramic granules. There, an overall oxidizing and exothermic reaction (7) occurred. Further endothermic/recombination processes took place in the deeper layer of the next (lower) catalyst, which was a mixture of nickel and cerium oxides, in a weight ratio of Ni/Cr=8 on the same carrier, until stable products of these processes passed through the perforated bottom/diaphragm 4 of the inner tank 3 at a temperature of about 500° C. and were directed, through the heat exchanger HEX, to the water vapor condenser 16 cooled by air and water. Approximately 60 L/h of tar-free water, free from organic compounds, was collected there. Thermal power of condensing water vapor (contained in the syngas) of about 50 KW could also be recovered for some use. The final clean syngas was slightly moist (saturated with water vapor at the condenser temperature) and contained (in % volume measured by the same Agilent μGC 490, recalculated to dry syngas): CO 31, H₂ 12, CO₂ 3, and (N₂+Ar) 54. The flow rate of this syngas at the outlet was about 330 m³(n)/h, and its enthalpic power (calculated) was 0.44 MW (HV). From the power balance, it followed that the processes occurring in the reactor corresponded to a thermal power of about 70 KW. From the syngas balance (sum of H₂ and CO): at the reactor inlet, it was 3.7 kmol/h, while at its outlet, it was as much as 6.2 kmol/h. The source of such an increase in the amount of syngas was the partially oxidizing conversion of tars and other organic substances contained in the primary gas produced in the pyro-gasifier.

In case an additional third layer of the WS catalyst were present in the reactor, placed near the bottom/diaphragm 4, hydrogen could be extracted from the purified syngas. Almost all of the steam would then react with carbon monoxide (CO), making the condenser 16 unnecessary. The high-hydrogen synthesis gas (or “hydrogen concentrate”) in this case would have the following composition (calculated in % vol.): CO 8, H₂ 28, CO₂ 20, and (N₂+Ar) 45. This would yield nearly 10 kg of “Green” Hydrogen per 0.14 tons of the exemplary moist wood feedstock.

### Example 2. Conversion of Pyrogas Derived from the Pyro-Gasification of Refuse-Derived Fuel (RDF) Waste

The carbonaceous material from the municipal waste sorting facility contained (in % by weight of dry matter): C, 42.5; H, 5.5; O, 25.5; N, 0.56; Sulfur(S) 0.14; Chlorine (Cl) 0.35, and mineral ash 25.5. It was nearly completely dry and had a higher heating value (HHV) of 18.1 MJ/kg. The hourly feed rate of this material was 0.10 tons per hour, corresponding to an input thermal/enthalpic power of 0.50 MW (HV). For pyro-gasification, 58 kg/h of air enriched with 40% vol. oxygen (O₂) was supplied, producing a polluted and moist process gas containing 73 g of tars per 1 m³(n), measured gravimetrically. Additionally, the gas contained hydrogen sulfide (H₂S), chloro-organic compounds, hydrogen chloride (HCl), methane (CH₄), and light hydrocarbons C₂-C₄.

Similarly to Example 1, the process gas leaving the pyro-gasifier was not cooled but was immediately transferred through an insulated pipe to the nearby SynGen reactor according to the invention to conduct selective conversion of tars and other carbonaceous gases, vapors, and mists into additional pure syngas. The composition of this moist and tarry “primary” syngas was (in % vol. determined using the mentioned Agilent μGC 490 apparatus): CO 39; H₂ 16; (N₂+Ar) 22; H₂O (v) 14; CO₂ 2.6; CH₄ 3.0; (C₂ to C₄) 3.2; C₁₀H₈ (averaged tars determined gravimetrically) 1.3. The calculated flow rate of this gas-vapor mixture and tarry feedstock to the reactor was 120 m³(n)/h, corresponding to 0.46 MW (HV).

Air enriched with 40% vol. oxygen was also added to the mixer 15, preheated in HEX, and the flow rate was dynamically controlled based on the double temperature measurement in the highest layer of the upper catalyst located in the inner tank 3. The first catalyst consisted of a mixture of nickel and cerium oxides with a Ni/Ce ratio of 0.5 on a support in the form of a monolith with ceramic and porous walls. The flow rate of the added air varied between 60 and 70 kg/h and was precisely controlled by a mass flowmeter in cooperation with the two mentioned thermocouples 13 placed in the hottest layer of the upper oxidizing catalyst. The next catalyst layer was a nickel monolith.

Within the inner tank 3, successive exo- and endothermic processes occurred until durable products of these processes passed through the bottom/diaphragm 4 of the container, directed to the tangential outlet 6 and through the heat exchanger HEX to the condenser 16 of water vapor cooled by air. There, about 15 L/h of tar-free water was collected, devoid of organic compounds, but acidified (0.35 kg/h) by hydrogen chloride HCl, which is the final product of oxidizing all organic chlorinated compounds contained in the feedstock. In the condenser 16, thermal power of 15 KW from water vapor condensation could also be extracted.

The final clean syngas was slightly moist and contained (according to analysis on Agilent μGC 490, in % vol, and calculated to dry syngas): CO 41, H₂ 24, CO₂ 4, and (N₂+Ar) 31. The syngas still contained 0.06% hydrogen sulfide (H₂S), which is the final product of conversion of all sulfur compounds present in the feedstock. The calculated flow rate of the syngas at the output was 180 m³(n)/h, and its enthalpic power (calculated) was 0.39 MW (HV). The power balance indicated that the processes occurring in the reactor corresponded to thermal power of about 60 kW. From the perspective of the syngas balance (sum of H₂ and CO), there were 3.0 kmol/h at the inlet of our reactor, while 5.1 kmol/h at the outlet. As previously, this increase in syngas quantity was due to selective and partially oxidizing conversion of tars and other organic substances present in the primary gas from the pyro-gasifier. This resulting syngas, representing 76% of enthalpic power compared to the power of the RDF feedstock at the entrance to the pyro-gasifier, can be used to power a classic gas piston engine; its specific combustion heat is equal to 2.2 kWh/m³ (n).

### Example 3. Conversion of Natural Gas (NG) to Syngas

The carbonaceous material was the network gas supplied to consumers in the vicinity of Warsaw. It contained (in % vol. based on measurements using the Agilent μGC 490 apparatus): CH₄ 96.8; C₂H₆ 1.9; CO₂ 0.2; N₂ 0.8 and had a calculated lower heating value (LHV) of 10.0 kWh/m³ (n). The hourly flow rate of this feedstock was 2.0 m³(n)/h, corresponding to an input thermal/enthalpic power of 20 KW (Lower Value LV). This gas was supplied, without preheating, to a small SynGen reactor according to the invention. The first catalyst layer consisted of a mixture of nickel and cerium oxides with a Ni/Ce weight ratio of 0.5 on a support in the form of a ceramic and porous granulate, and the second catalyst layer also consisted of a mixture of nickel and cerium oxides with a Ni/Ce weight ratio of 10 on the same support. Air enriched with 40% vol. oxygen (O₂) was added to the mixer 15, preheated in HEX, and the flow rate was dynamically controlled based on the double temperature measurement in the highest layer of the upper catalyst located in the inner tank 3. The flow rate was 3.3 m³(n)/h and was precisely controlled by a mass flowmeter in cooperation with the two mentioned thermocouples 13 immersed in the hottest layer of the upper oxidizing catalyst. The conversion products of NG passed through the lower catalyst, and then through the perforated bottom/diaphragm 4 of the container and were directed to the gas separation installation. The final clean syngas output was 7.6 m³(n)/h. It contained (in % vol., dry gas, according to Agilent μGC 490): CO 24, H₂ 47, CO₂ 3, and (N₂+Ar) 26. The molar ratio of H₂/CO=2.0 was particularly interesting for using such syngas for Fischer-Tropsch wax synthesis.

### Example 4. Conversion of Natural Gas (NG) to Syngas and then to Hydrogen Concentrate

The same network gas (from Example 3) with the same flow rate was converted in the same reactor, but with an additional third lower layer of a commercial Water Shift (WS) catalyst. The oxidizing agent for the POX process was also air enriched with 40% vol. oxygen and preheated in HEX. The flow rate of this oxidizer was slightly larger and amounted to 4.0 m³(n). However, the amount of water vapor produced in the excess (ε=0.20) POX oxidation process (reaction 6) was not sufficient to convert 90% of CO (reaction 3) in the syngas leaving the second catalyst layer, and therefore an additional stream of 0.3 kg/h of preheated water vapor was introduced into the mixer 15. Almost dry conversion products of NG passed through the perforated bottom/diaphragm 4 of the container and could be directed to the gas separation installation. The final clean syngas output was 9.1 m³(n)/h. The syngas contained (in % vol., dry gas, according to Agilent μGC 490): CO 2, H₂ 51, CO₂ 20, and (N₂+Ar) 27. Particularly interesting would be the output of pure hydrogen (after applying some extraction system) amounting to 0.42 kg/h compared to 0.32 kg/h of H₂ in Example 3 without the addition of water vapor and without an additional WS catalyst.

### Example 5. Conversion of Creosote

The carbonaceous material was waste oil from the pyrolysis of beech wood for charcoal production in the Bieszczady Mountains. The elemental composition of this ash-free oil (in % by weight): C, 72.3; H, 7.05; O, 20.6; N₂ 0.8. This bio-oil (recently considered toxic) has a high higher heating value (HHV) of 31.4 MJ/kg but is not suitable as fuel for piston engines. The hourly flow rate of this feedstock was 3.0 kg/h, corresponding to an input thermal/enthalpic power into the reactor of 26 KW (HV).

The creosote was heated to 150° C. (below its boiling point) and injected into the mixer 15 of a small GlidArc reactor according to the invention, with catalysts as in example 3 but with Ni/Ce weight ratios of 0.6 in the first layer and 5 in the second layer. Air was added to the head/mixer 15, preheated in the HEX heat exchanger, and the flow rate was dynamically controlled based on the double temperature measurement in the hottest, upper layer of this catalyst located in the inner tank 3. The flow rate was 9.5 m³(n)/h and was precisely controlled by a mass flowmeter in cooperation with the two mentioned thermocouples 13 immersed in the hottest, upper layer of this catalyst. The conversion products passed through the perforated bottom/diaphragm 4 of the container and were directed to the outlet 6, and then through the heat exchanger HEX to the steam condenser 16 cooled by air. Here, 0.2 L/h of pure water was collected. The final output of clean syngas was 7.6 m³(n)/h. The syngas contained (based on Agilent μGC 490 analysis, in vol. % and for dry syngas): CO 27, H₂ 16, CO₂ 3, and (N₂+Ar) 55. This resulting syngas, with a flow rate of nearly 14 m³(n)/h, represented an enthalpic power (HV) of 20 KW (which is 77% of the power of creosote at the reactor inlet). Waste creosote (as well as other pyrolytic oils) can, therefore, be utilized to power classical cogeneration systems after its conversion into clean synthesis gas.

1. A method for catalytic oxygenation conversion of carbonaceous combustible matter into synthesis gas using a partial oxidation (POX) method, characterized in that said carbonaceous matter in gaseous, vapor, or ash-free liquid form is oxygenated by an oxygenating agent in the presence of two consecutive POX catalysts supported on layered carriers. The first layer catalyst consists of a mixture of nickel and cerium oxides with a weight ratio of Ni/Ce ranging from 0.5:1.0 to 1.0:1.0, exhibiting oxidizing properties towards said matter at temperatures ranging from 1200 to 800° C. The second catalyst layer comprises metallic nickel or a mixture of nickel and cerium oxides with a weight ratio of Ni/Ce ranging from 2.0:1:0 to 10.0:1.0, demonstrating reduction-recombinatory properties at temperatures ranging from 800 to 300° C. The temperatures within the layers of these catalysts gradually change along the direction of the inflowing feedstock from a maximum of 1200° C. upon contact with the first layer to a minimum of 300° C. at the outlet of the synthesis gas, which is the product of this conversion. The temperature of the first, initially cold catalyst layer during cold start-up is raised to at least 750° C. using a gliding electrical discharge GlidArc, after which the discharge is stopped.

2. The method according to claim 1, characterized in that atmospheric air or air enriched with up to 40% by volume of O₂ is used as the oxygenating agent.

3. The method according to claim 1, characterized in that the catalysts are supported on a multi-channeled, high-alumina ceramic monolith with porous walls or on a nickel monolith or supported on porous high-alumina mineral granules.

4. The method according to claim 1, characterized in that an additional Water Shift (WS) catalyst layer is used after the second POX catalyst layer, where total or partial conversion of carbon monoxide (CO) into hydrogen (H₂) is carried out based on a process involving steam.

5. The method according to claim 1, characterized in that the flow of the oxygenating agent is adjusted and controlled in relation to the temperature of the highest catalyst layer, such that when the temperature of the highest catalyst bed segment drops below 750° C., the supply of the oxygenating agent is interrupted, and the cold start-up process is repeated to restore the proper temperature distribution in subsequent catalyst segments.

6. The method according to claim 1, characterized in that the pressure inside the reactor is maintained within the range of 0.8 to 1.2 bar absolute.

7. A reactor for catalytic oxygenation conversion of carbonaceous combustible matter using a partial oxidation (POX) method into synthesis gas, characterized by comprising an outer vessel (1) and an inner vessel (3) placed inside it with a perforated diaphragm (4), in which two consecutive POX catalysts (10) are arranged in layers, supported on carriers. The first catalyst layer (11) consists of a mixture of nickel and cerium oxides with a weight ratio of Ni/Ce from 0.5 to 1, exhibiting oxidizing properties at temperatures from 1200 to 800° C., while the second catalyst layer (12) consists of metallic nickel or a mixture of nickel and cerium oxides with a weight ratio of Ni/Ce from 1 to 10, demonstrating reduction-recombinatory properties at temperatures from 800 to 300° C. At least two independent temperature sensors (13) are placed in the first catalyst layer (11), and the outer (1) and inner (3) vessels are covered with the same sealed cover (5), in which an inlet (7) for the carbonaceous material and oxygenating agent and electrodes (14) for igniting the GlidArc plasma, initiating and controlling the cold start-up of the reactor are located, while the reactor's outlet is formed by a tube (6) attached to the outer vessel (1).

8. The reactor according to claim 7, characterized in that below the second catalyst layer (12), there is an additional Water Shift (WS) catalyst layer.

9. The reactor according to claim 7, characterized in that the catalyst carriers (11) and (12) are multi-channeled ceramic monoliths with porous walls or nickel monoliths or porous high-alumina mineral granules.

10. The reactor according to claim 7, characterized in that the external surface of the outer vessel (1) is covered with a layer of thermal insulation (2).

11. The reactor according to claim 7, characterized in that the cover (5) of the vessels (1) and (3) is protected from the hot first catalyst by a thermal screen (8).
